(19) United States
(12) Patent Application Publication
(10) Pub. No.: US 2007/0107664 A1
(43) Pub. Date: May 17, 2007

(54) Landscaping pond system and method with variable opening falls and tesserae geometry

(75) Inventors: Gary Grant Wittstock, Elburn, IL (US); Jeffrey Lynn Rugg, Montgomery, IL (US); Jason E. James, Plano, IL (US)

Correspondence Address: DYKEMA GOSSETT PLLC, 39577 WOODWARD AVENUE, SUITE 300, BLOOMFIELD HILLS, MI, 48304-5086, US

(73) Assignee: PondSweep Manufacturing Company

(21) Appl. No.: 11/274,730

(22) Filed: Nov. 15, 2005

(51) Int. Cl. A01K 63/00

(52) U.S. Cl. 119/246

(57) ABSTRACT

The present invention relates generally to an improved falls box as part of a filtration and water circulation system for artificial ponds and other bodies of water and, more particularly, to an improved falls box of a design and method of use that allows for vertical stacking during storage, the vertical use of a multitude of support grids to fill the cavity, the use of support ribs in an intermediary section to support aesthetic additions, an upper surface that can be opened to orient the horizontal flow across the box and create one or a plurality of artificial falls, the capacity of connecting a plurality of falls boxes in series to create a filtration cross-flow through falls boxes, the use of the falls box in a plurality of ways as a pump vault box in a disappearing water recuperation system either in connection with a falls box, by itself, upside down, in order to create an underground vegetation system, a disappearing falls system, a small pond, or a disappearing falls filter, and a tessellated upper geometry that allows connecting edges between boxes to be joined in a plurality of methods to create complex water surfaces.

### FIELD OF THE INVENTION

The present invention relates generally to an improved falls box as part of a filtration and water circulation system for artificial ponds and other bodies of water and, more particularly, to an improved falls box of a design and method of use that allows for vertical stacking during storage, the vertical use of a multitude of support grids to fill the cavity, the use of support ribs in an intermediary section to support aesthetic additions, an upper surface that can be opened to orient the horizontal flow across the box and create one or a plurality of artificial falls, the capacity of connecting a plurality of falls boxes in series to create a filtration cross-flow through falls boxes, the use of the falls box in a plurality of ways as a pump vault box in a disappearing water recuperation system either in connection with a falls box, by itself, upside down, in order to create an underground vegetation system, a disappearing falls system, a small pond, or a disappearing falls filter, and a tessellated upper geometry that allows connecting edges between boxes to be joined in a plurality of methods to create complex water surfaces.

### BACKGROUND OF THE INVENTION

Landscaping, interior design, and bio-environment design has always been an important part of human culture. Water is the central feature of most bioengineered ecosystems. In the first century B.C., the Greek geographer Strabo, describing the Hanging Gardens of Babylon, focused on the ingenious Assyrian water circulation system, stating “At their side are water engines, by means of which persons, appointed expressly for the purpose, are continually employed in raising water from the Euphrates into the garden . . . lifting the water far into the air so it could flow down through the terraces.” Technology has modernized this important invention.

In recent decades, the use of artificial water environments in conjunction with household structures or commercial real estate has increased significantly. Owners purchase “artificial pond kits” or mandate service providers to design and build artificial ponds in their gardens, back yards, or commercial environments. Gary Wittstock, one of the present inventors, patented the first artificial falls system in 1996. FIG. 1 of U.S. Pat. No. 5,584,991 illustrates this general invention. The system includes a skimmer box and a falls box located at different positions on the periphery of a body of water. The skimmer box draws in surface water transporting suspended or floating debris to a dynamic, biologic, or chemical filter. Inhabitants of this ecosystem, such as fish and turtles, are protected from recirculation via a mechanical or bacterial filtering system located within the skimmer box that removes, stores, and destroys the debris in a nonhurtful way. A pump located past the filtration circulates the water up to the second box, called the “falls box,” which is placed somewhat above the surface of the body of water. Water pumped into the falls box cascades over a lip and back to the lower body of water, creating a closed loop ecosystem that includes an aesthetically pleasing artificial waterfall.

In 2000, Gary Wittstock obtained U.S. Pat. No. 6,054,045 relating to novel improvements to the skimmer box as used in conjunction with the artificial pond system described in U.S. Pat. No. 5,584,991. The current invention relates to improvements to the falls box as used generally in an artificial pond ecosystem as generally described in U.S. Pat. No. 5,584,991, hereby incorporated fully by reference. U.S. Pat. No. 6,054,045 is also hereby incorporated fully by reference.

The needs of landscaping artists, consumers, homeowners, or even real estate developers has evolved beyond the use of a single symmetrical waterfall pouring out of a single falls box. Natural waterfalls generally are not limited to a single cascade of a fixed width, and the needs of landscaping artists can vary greatly. New, artificial designs need to provide a plurality of waterfalls of variable lengths and variable flows, creating an effect of water trickling from rock ledges to the main body of water based on highly flexible and adaptable methods. Designers are no longer satisfied with a small surface of water located before the waterfall. Water systems that imitate streams, lake fronts, and other designs are needed for a forced flow allowing water to be circulated, cleaned, and biologically treated as generally described in U.S. Pat. No. 5,584,991.

Using existing falls boxes, landscape artists must purchase differently sized falls boxes designed for a single waterfall layout of fixed waterfall size to create a plurality of falls. Under this configuration, the circulation pump must send water into each independent falls box through different water inlets. As dirt and debris accumulates in different quantities in each falls box, the regulation of the flow of water will change and flow may trickle in a first waterfall while flowing abundantly in a second waterfall. The use of a plurality of falls designed to work individually, when used as a composite system, creates, among other things, storage, fixation, flow, and water inlet problems.

Currently, designers wishing to create a landscape with a complex water system configuration, such as a stream or an artificial ring of water around an island, use classical means such as a cement casting or a pool liner to shape their desire surfaces. A falls box would then be inserted where a waterfall is desired, immediately upstream of the artificial waterfalls. Using this system, water in this artificially created upstream surface could stagnate.

### SUMMARY OF THE INVENTION

An object of this invention is to address the above-described problems, namely, to provide landscape designers with a flexible, variable, and customizable multiple-falls system, a method that allows for the design of upstream variable geometries, bodies of water, and a system with a plurality of falls.

The present invention relates generally to an improved falls box as part of a filtration and water circulation system for artificial ponds and other bodies of water and, more particularly, to an improved falls box design and method of use that allows vertical stacking during storage, vertical use of a multitude of support grids, use of support ribs in a intermediary section, a customizable top surface to orient the flow across the box and create one or more desired artificial falls, capacity for connecting a plurality of falls boxes in series to create a filtration cross-flow through falls boxes, the use of the falls box in a plurality of ways, such as a pump vault box in a disappearing water recuperation system either in connection with a falls box, by itself, upside down, in order to create an underground vegetation system, a disappearing falls system, a small pond, or a disappearing falls filter, and a tessellated upper geometrically that allows connecting edges of boxes to be joined efficiently to create and optimize spatially complex water surfaces.

A first novel feature of this invention is the addition of a geometrical shape as commonly observed in floor tiling, where a single or a limited number of different geometries are assembled or tiled to cover larger surfaces. The term commonly used by modern Euclidian geometry mathematicians to define such tiling surfaces is “tessellate.” For the purpose of this patent application, the term “tessellatd” shall include the use of one or a plurality of geometries as part of an overall tessellate pattern.

In a preferred embodiment, the falls box is designed with semi-irregular geometry to help create an overall impression of a semi-irregular area such as a stream or water edges. The humid surface to cover may include inner “dry” areas where no water is found. For example, falls boxes may be arranged in a closed loop configuration where foliage and vegetation is inserted in the center loop. Rocks, vegetation, or other decorative elements are also arranged around the periphery of the water's edge, with the exception of the location of artificial waterfalls, to protect from overflow and to help camouflage the falls boxes. The use of a single improved falls box is also contemplated.

Falls boxes, when joined, form a composite surface. Boxes are secured to each other using mechanical means such as bolts or clamps. In order to direct the flow of water across the horizontal surface, either cuts are made in the upper periphery walls between falls boxes or a heightened section is created around the periphery of the outer walls by adding rocks, decorative foliage, or other mechanical elements arranged to contain the flow of water and force a resulting falls at the desired location. A section of the upper periphery may be cut in each adjacent box to conduct the water between boxes and back to the main body of water. In order to optimize the flow path between two adjacent boxes, a first section of the lateral periphery wall is removed in a first box and side openings are made on each side of the flow path where a mechanical means is to be used. These three openings are then used as guides to make adjacent openings in an adjacent falls box once both boxes have been secured in their final configuration.

The falls boxes do not have a precut area in the outer upper periphery. This allows designers to selectively open areas between falls boxes to force the horizontal surface flow in any desired radial location. Designers may open one or more areas next to the main body of water to create a single waterfall or a plurality of waterfalls at chosen locations around the resulting water surface. Falls boxes allow for the removal of any radial section, including the corner of a box. Two or more openings can be made in a single falls box, resulting in a multiple-falls system using a single falls box. A premolded insert in the shape of an artificial rock ledge may be inserted over the tessellate outer ledge to create an artificial waterfalls opening.

The horizontal section of the main body of the falls box is designed to allow a horizontal support grid, generally opposed to a horizontal ridge near the bottom of falls box, to be rotated to a vertical orientation. Filtration materials can be placed on the support grid in the horizontal orientation to partly fill in the cavity. If aesthetic elements are placed over the center area of a falls box, a plurality of horizontal support grids are inserted in the vertical position to fill in the falls box cavity. The vertical height of the top of the horizontal ridge is located within the box cavity so that vertical stacking of a plurality of falls boxes is possible and designed to optimize and reduce the overall height of a plurality of falls boxes when they are interlocked and stacked vertically. The vertical height of the top of the horizontal ridge also is designed to allow vertical stacking of a plurality of grids within the cavity of the fall box while maintaining the top part of the grids from raising above the water level.

A pond liner, as described in U.S. Pat. No. 5,584,991, is located under the main body of water and is secured to the falls box around the outer periphery of all openings made above the body of water where artificial waterfalls are created. A pond liner may be used as part of the water confinement system, but other watertight systems, such as concrete, may be used. Since the number, location, and width of each waterfall may vary according to the needs of the user, the pond liner attachment system is also modular in length. A thick, linear strip of material is cut at the horizontal width of a first waterfall opening in a falls box. Two other lengths of the thick, linear strip are cut corresponding to the vertical height of the falls box waterfall opening. In the preferred embodiment, the linear strip material serves as an additional barrier that limits the flow of water, or leaks between the falls box waterfall opening and the pond liner. Regularly spaced holes or equivalents are punctured or drilled around the outer periphery of waterfalls openings. The pond liner is also cut or bent locally so as not to obstruct the passage of the water in the waterfall opening. In one embodiment, tie fasteners with linear mechanical compression or other compression-based systems, such as magnets or pincers, are then used to pinch the liner between the outer surface of the falls box and the inner surface of the thick, linear strip of material. In the preferred embodiment, a silicone-based sealing compound is used to seal the liner to the falls box.

Where the horizontal surface of the upper periphery of a geometrical shape is wider than the horizontal surface of the main falls box cavity, an angled connecting wall linking the upper periphery to the top of the box cavity is equipped with thin vertical support ribs to create a surface upon which rocks, plants, and other aesthetic elements can be laid.

Water is circulated from the skimmer box to at least one falls box by a water inlet attached to the falls box's main cavity. While water is generally the liquid of choice used in the design of artificial ponds, this invention is also applicable to other liquid-medium artificial ponds as long as the viscosity of the fluid is sufficiently low to allow for dynamic flow across the surfaces of the falls box.

Paving of a global surface using a box with a tesserae geometry may be conducted by the assembly of a plurality of falls boxes, which each possess tesserae properties either by itself or in combination with another associated shape, forming a global tesserae shape.

The falls box may also be used in a plurality of auxiliary arrangements to perform other functions within the same technical field. The surface of the container can be covered with a plurality of flow holes and placed upside down within a liquid saturated environment such as a water and rock basin, or right-side-up with a mechanical covering means, such as a grate, a plastic cover, or any other type of physical barrier. The volumes created inside the falls box then serve as water volumes, which allow for better control of water in the basin and optimize the biochemical formulation of the liquid saturated environment.

In another auxiliary arrangement, falls boxes can be arranged in a serial configuration, where liquid flows from one falls box to the next via a means of transfer, either an aperture, a water inlet, a tube, or other means. Liquid is deposited in the first falls box through an inlet and then flows upwards in the cavity of the first falls through a first filtration system. Liquid is then transferred by mechanical means, either gravity, pressure differential, forced flow, or pumping force, to a second falls box. Liquid is then moved downward through a second filtration system. The resulting system allows for better overall filtration and a different control of the flow.

In yet another auxiliary arrangement, a falls box is placed in a liquid saturated environment and either covered or filled with elements from the liquid saturated environment, such as rocks, sand, or other debris. The falls box can also be filled with liquid to create a small pond. A liquid circulation means, such as a pump, is placed on the bottom of the falls box and circulates water to an elevation above the liquid saturated environment surface. Liquid then returns to the liquid saturated environment surface under the attraction of gravity, creating a waterfall in the process. Liquid can also be circulated to a second falls box.

In yet another auxiliary arrangement, a falls box is inserted upside up in the liquid saturated environment. The volume created inside the cavity of the falls box contains a circulating means, but the rest of the volume is filled with liquid. The circulating means circulates the water either to an elevation above the surface of the liquid saturated environment or to a second falls box.

### BRIEF DESCRIPTION OF THE DRAWINGS

A better understanding of the present invention may be derived from the detailed description and the claims when considered in connection with these figures. The reference numbers refer to similar elements throughout the figures.

FIG. 1 is a reproduction of FIG. 1 as found in U.S. Pat. No. 5,584,991 as prior art of a diagrammatic side elevation view of a preferred embodiment of a filtration system for ponds as patented by Gary Wittstock;

FIG. 2 is a top view of a decorative landscaping pond and its main components;

FIG. 3A is a perspective view of the preferred embodiment of the falls box with no precut section of the connecting wall;

FIG. 3B is a perspective view of the preferred embodiment of the falls box with a frontal precut area in the connecting wall;

FIG. 3C is a perspective view of the preferred embodiment of the falls box with a front corner precut area in the connecting wall;

FIG. 3D is a perspective view of the preferred embodiment of the falls box with a lateral precut area in the connecting wall;

FIG. 4 is a perspective view of two falls boxes assembled to form a global falls with a single frontal precut area and adjacent opening in both connecting walls;

FIG. 5 is a side view with partial perspective of FIG. 3A;

FIG. 6A is a schematic top view of a first possible arrangement of three falls boxes into a composite falls;

FIG. 6B is a schematic top view of a second possible arrangement of five falls boxes arranged in a semistream-like configuration forming a composite falls;

FIG. 6C is a schematic top view of a third possible arrangement with ten falls boxes arranged in a loop-like configuration forming a composite falls;

FIG. 6D is a schematic top view of a fourth possible arrangement with eight falls boxes arranged in a pond like configuration into a composite falls;

FIG. 7A is a side view with partial perspective of FIG. 3A where two falls boxes are vertically stacked;

FIG. 7B is a close-up view of FIG. 7A illustrating the horizontal ledge where stacking occurs;

FIG. 8A is a flow diagram showing a series of method steps performed to implement the method for joining two falls into a composite falls;

FIG. 8B is a flow diagram showing a series of method steps performed to implement the method for joining two falls into a composite falls where a section is also opened;

FIG. 9A is an isometric exploded view of the attachment of the pond liner to the falls box and the use of a false ledge;

FIG. 9B is a top view of a falls box equipped with two false ledges;

FIG. 10A is a top view of a falls box equipped with a horizontal support grid resting on a ledge;

FIG. 10B is an isometric view of a falls box equipped with a support grid resting on a ledge and filtration means on top of the support grid;

FIG. 10C is a side cut-off view of the falls box of FIG. 10A along the dotted line;

FIG. 10D is a side cut-off view of the falls box of FIG. 10A along the dotted line where a plurality of support grids is stacked vertically;

FIG. 11A is a flow diagram showing a series of method steps performed to secure a pond lining to a falls box using a variable length fixing strip;

FIG. 11B is a flow diagram showing a series of method steps performed to secure a pond lining to a falls box using a variable length fixing strip at a second location;

FIG. 12 is a side view of the falls box used as a liquid vegetation filter cleanout system;

FIG. 13 is a side view of the falls box used as a multiple-step cross flow filtration system;

FIG. 14A is a side view of a possible embodiment of the falls box used as a self-sustained water flow system and pump vault box;

FIG. 14B is a side view of a second possible embodiment of the falls box used as a self-sustained water flow system and pump vault box;

FIG. 14C is a side view of a third possible embodiment of the falls box used as a self-sustained water flow system and pump vault box;

FIG. 15A is a side view of the falls box used upside down as a buried filtration box in association with a falls box;

FIG. 15B is a side view of the falls box use right side up as a buried filtration box in association with a falls box; and

FIG. 15C is a side view of the falls box used right side up as a buried pond box in association with a falls box.

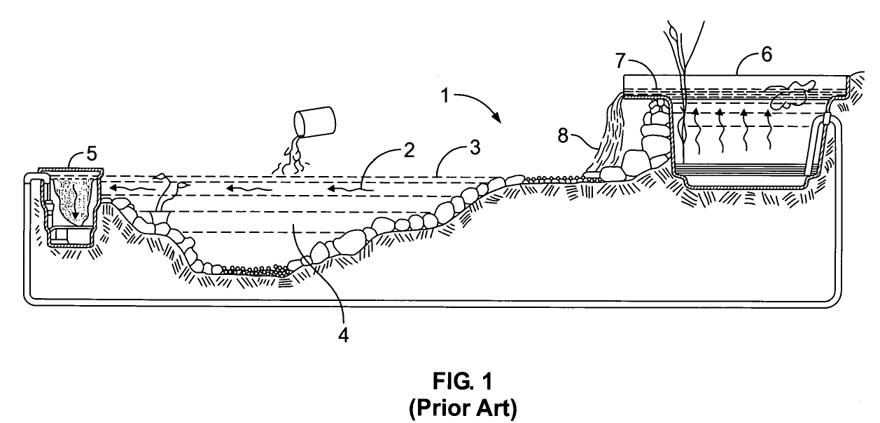

### DETAILED DESCRIPTION OF THE INVENTION

Where reference numerals represent the same elements in all of the views, FIG. 1 illustrates a diagrammatic side elevation view of an embodiment of a general filtration system for ponds taken from U.S. Pat. No. 5,584,991, hereby incorporated by reference. The original reference numerals of the illustration incorporated have been removed for the purpose of clarification and new reference numerals have been added.

This invention relates generally to a closed-loop artificial pond water purification system 1. A forced flow 2 is created across the surface 3 of a pond 4. Water or any other viscous liquid capable of dynamic flow is circulated from a skimmer box 5 to a falls box 6. Water is filtered both in the skimmer box 5 and in the falls box 6 for biological elements, debris in suspension, or any other element to be removed from the pond water. The skimmer box 5 is also further described in U.S. Pat. No. 6,054,045, also hereby incorporated by reference.

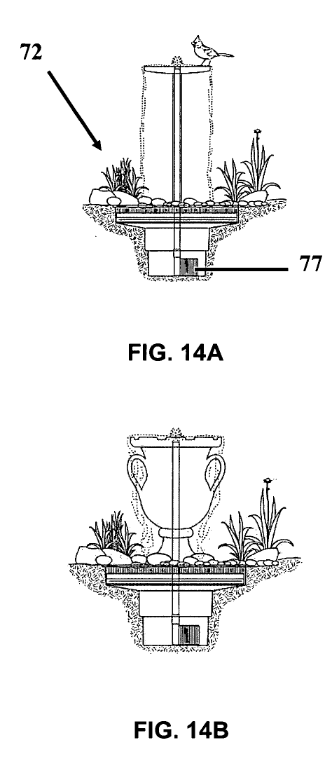

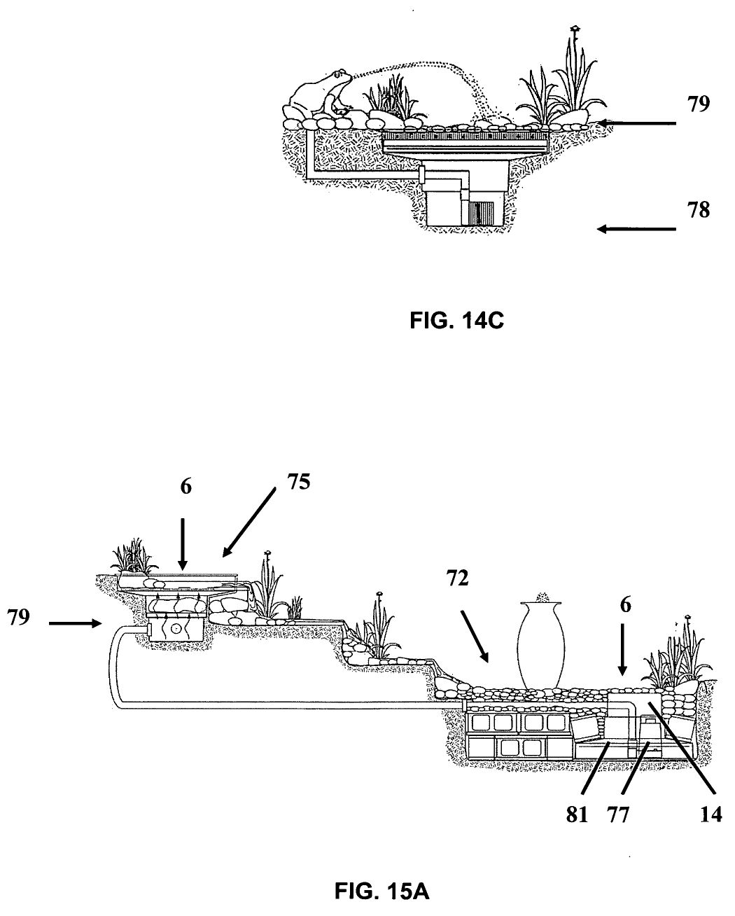

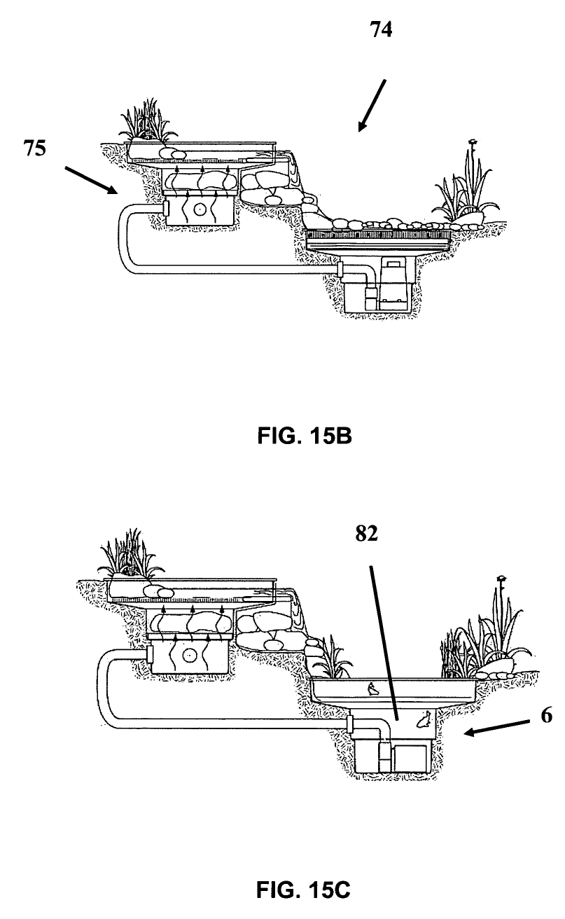

The skimmer box 5 draws in water through overflow from the pond. The excess of water is circulated to the falls box 6 and is directed back in the pond 3 via an opening 7 made in the falls box 6. If the falls box is located above the pond water level, an artificial falls 8 is created by the water pouring out of the falls box 6. A complete description of the water circulation system is provided in U.S. Pat. No. 5,584,991, hereby incorporated by reference. Another embodiment shown in FIGS. 14A to 15B allows for a similar system where the pond 3 is removed and/or the falls box 6 is also removed from the system.

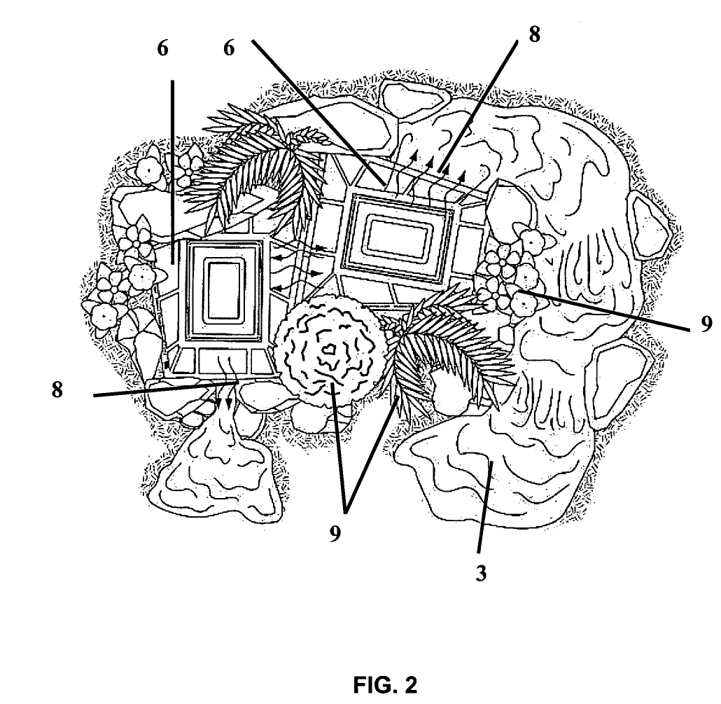

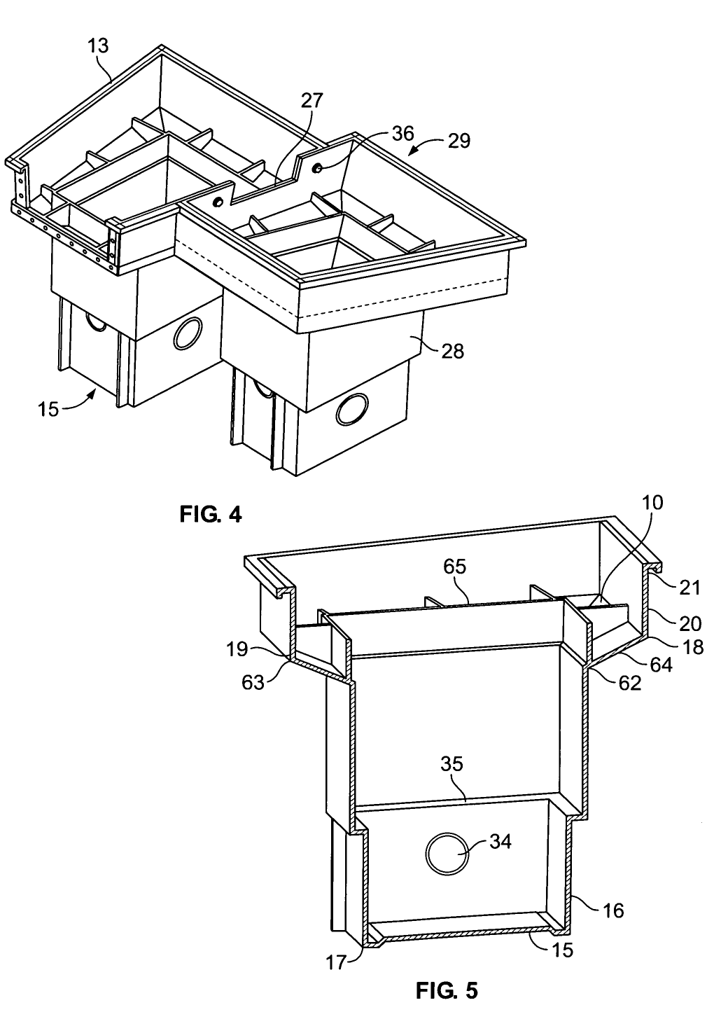

FIG. 2 illustrates a top view of the general arrangement where two falls boxes 6 are used in a landscape arrangement. Not shown on FIG. 2, the general arrangement can be used with a skimmer box 5, as described in the prior art, or another falls box 6, as shown in FIGS. 15A to 51C. The arrangement allows for two or more falls to be created either using a single falls box 6 or a plurality of falls boxes in a combination as described hereunder. Vegetation, rocks, or other aesthetic elements 9 are arranged appropriately around the edges of the created pond 3 to hide the falls boxes 6 and to create a natural look. FIG. 2 is only illustrative of one of numerous possible arrangements or layouts of this modular multiple-falls invention. In one of the preferred embodiments, two falls boxes 6 are located at different locations around the periphery of the pond 3 at different elevations above the water level. In one falls box 6, a single opening is made and boxes are attached as shown in FIG. 4, while the second falls box 6 also has one opening. Resulting artificial falls 8 are also shown.

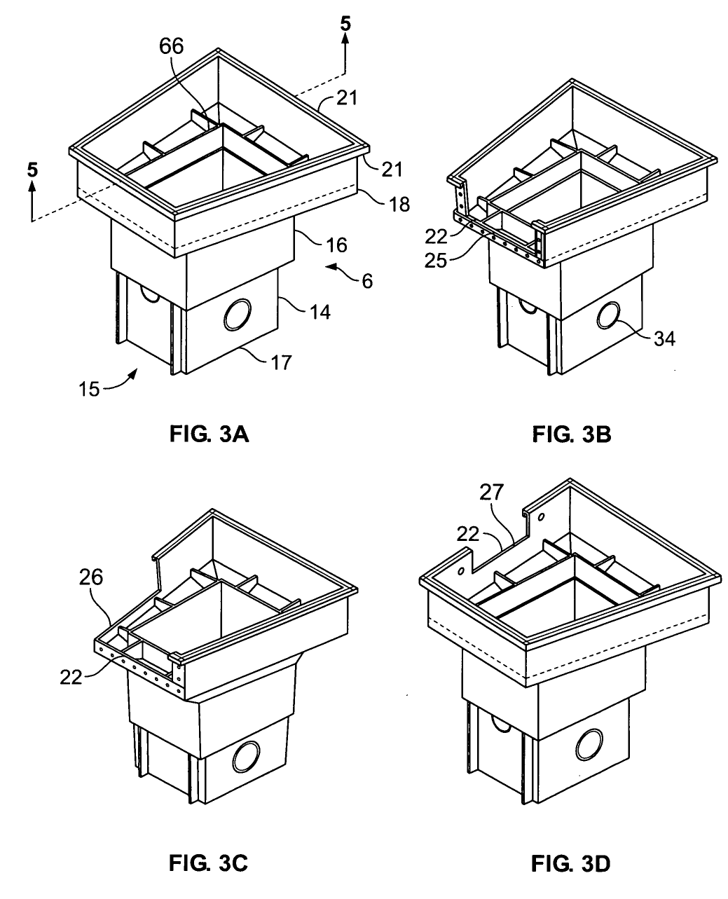

FIGS. 3A, 3B, 3C, and 3D are perspective views of a preferred embodiment of the falls box 6, each with different configurations. FIG. 3A shows a falls box with no opening in its connecting wall, FIG. 3B illustrates a frontal opening in the connecting wall, FIG. 3C illustrates the same falls box 6 with a corner opening, and FIG. 3D illustrates a possible location for a lateral opening. Each falls box 6 is made of a container 14 where water is placed. The container 14 is formed by the union of a bottom wall 15 and a side wall 16 attached at the bottom edge of the side wall 17. The top edge 18 of the side wall 16 is attached in turn to the bottom edge 19 of a tesserae connecting wall 20. The top edge 21 of the connecting wall 20 in the preferred embodiment is reinforced by a horizontal ledge 21. In the preferred embodiment, the container 14 is made of molded plastic of opaque color.

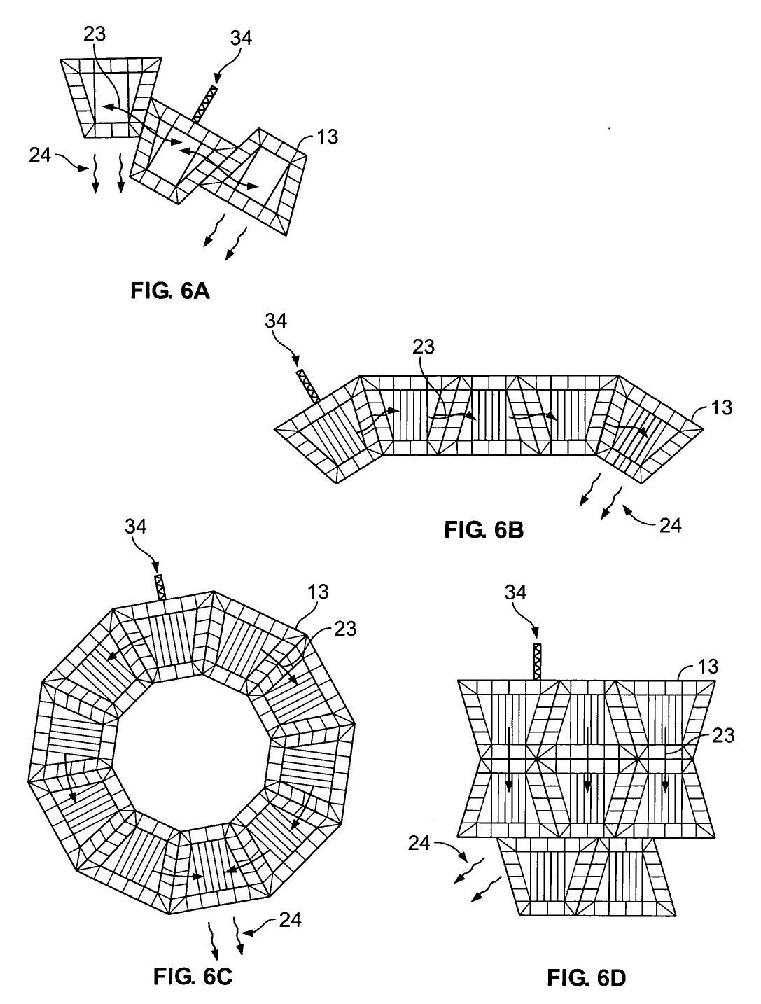

The shape of the geometrically compatible connecting wall 20 is designed to be of such geometry as to allow the tiling of a plurality of falls boxes when they are laid out on the same horizontal level. This well-known effect in the tiling industry is referred to as a tesserae shape. There is a very large number of possible geometrically compatible shapes that can be conceived for the connecting wall 20 based on mathematical concepts of tiling geometry. Some types of tiling, such as the Penrose Shapes, require two or more geometries to cover the entire surface; such shapes are also contemplated by this invention. In the preferred embodiment, the shape of the tesserae connecting wall 20 as shown in FIGS. 6A to 6D is a four-sided polygon called a isosceles trapezoid, where the length of one of the parallel sides is a large fraction of the opposite side.

While openings 22 can be made in the connecting wall 20 to create or force a preferential flow of water 23 across the surface as illustrated on FIGS. 6A to 6D, the preferential flow of water 23 across the surface can also be made by creating an artificial elevation around a large part of the periphery 13 of the pond over the geometrically compatible connecting wall 20 by using either a mechanical device, rocks, or aesthetically pleasing vegetation 9. In the preferred embodiment, at least one opening 22 is made next to a depression in order to create an artificial waterfall 24.

Openings in the tesserae connecting wall 20 can be made of any width, length, or height and in any quantity. In the preferred embodiment, three major types of openings have been contemplated: a frontal/read opening 25 as illustrated by FIG. 3B, a corner opening 26 as illustrated by FIG. 3C, and a lateral opening 27 as illustrated by FIG. 3D. Other types of openings along the connecting wall are also contemplated.

A falls box 6 can be secured to a second related falls 28 of an associated tesserae shape 20, creating a global composite falls 29 made of at least two falls. In a preferred embodiment, two falls boxes 6 are secured into a composite falls 29 at the adjacent lateral opening 27. FIGS. 6A to 6D illustrate possible arrangements of global composite falls 29. In a first illustration, shown as FIG. 6A, the falls boxes 6 are secured via lateral openings 27 (not shown) located outside the central zone of each adjacent lateral wall. In FIG. 6B, the falls boxes 6 are arranged in semilinear fashion, where each falls box 6 is attached laterally. For example, such a semilinear distribution may be used to resemble a naturally occurring stream 31. FIG. 6C illustrates a possible man-made, aesthetically pleasing pattern where vegetation, rocks, or other aesthetic elements may surround the stream of water. Finally, FIG. 6D illustrates a possible configuration of an irregularly shaped body of water 33. The proposed arrangements serve to illustrate a handful of possible configurations that may be conceived using this invention. These configurations correspond to the preferred embodiments presently contemplated. Arrows illustrate on each of these four figures a possible preferential flow 23 of water.

FIG. 5 shows in greater detail the configuration of the container 15 as found in the preferred embodiment. A water inlet 34 allows for the entry of water into a falls box 6. Water inlets 34 may be inserted in any falls box forming a composite falls 29 as shown in FIG. 4. In the preferred embodiment, a single water inlet is used, but any number of different inlets with different flows of water may be used to achieve the purpose of the landscaping artist.

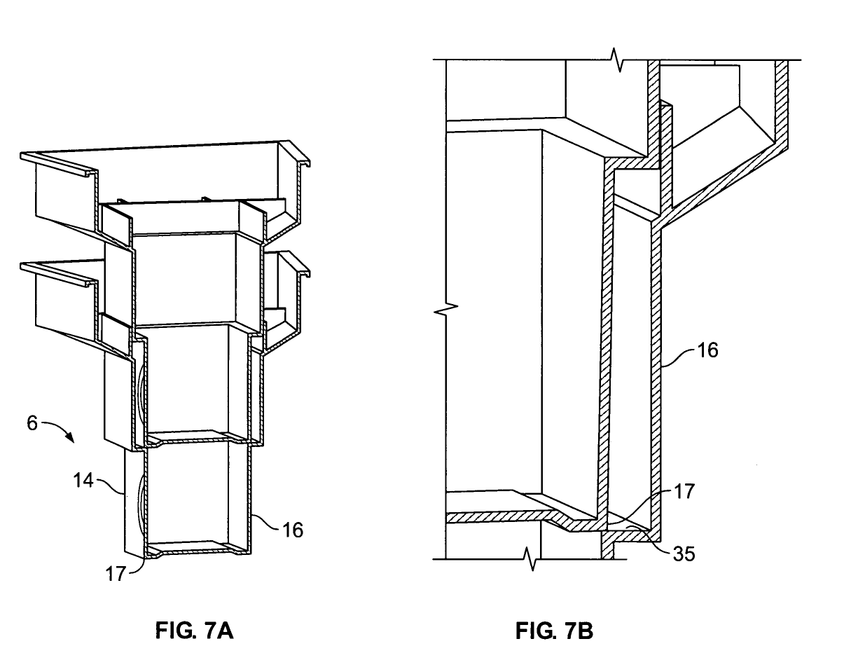

The falls boxes 6 may be stacked vertically in order to optimize production, shipping, and storage. FIG. 7A illustrates how two or more falls boxes 6 may be stacked vertically by inserting a second falls box into the first until the bottom edge of the side wall 17 of the second falls box rests on the horizontal ledge 35 of the first falls box. The ledge 35 is located at a certain height on the side wall 16 of the first falls box to allow vertical stacking without interference between the first falls box and the second falls box. FIG. 7B is a close-up view of the horizontal ledge 35 as found in the preferred embodiment.

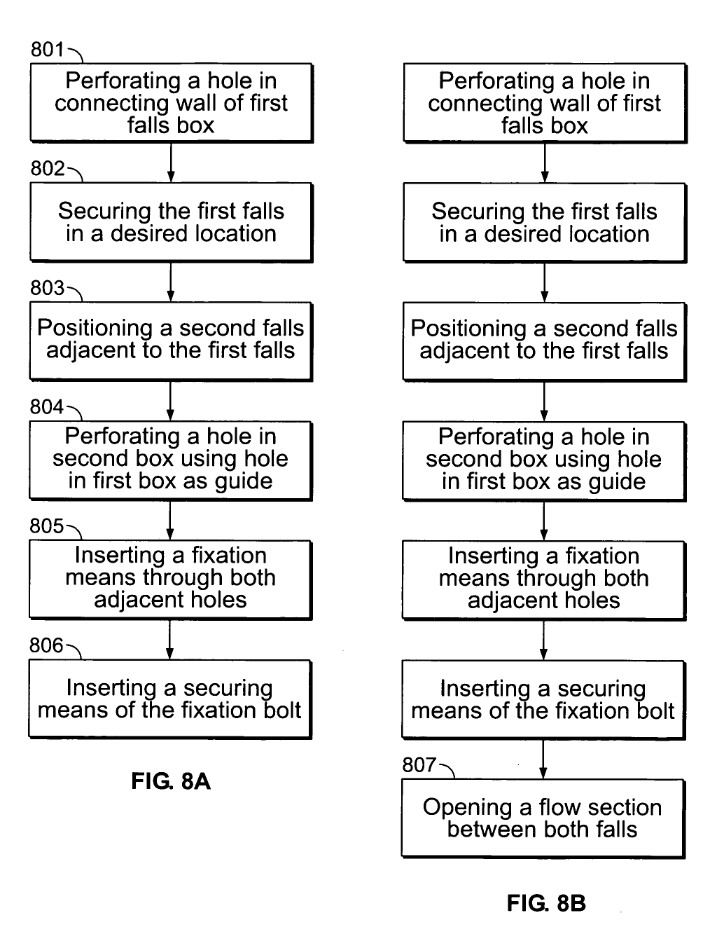

A specific method to join two geometrically compatible falls into a composite falls as illustrated by FIG. 4 is shown in FIG. 8A. This method was performed after observing that if the precut guiding holes 36 in both falls boxes 6 are made before securing the boxes in their final location, movements and displacements between the two falls boxes prevent the proper alignment of the guiding holes 36. A first guiding hole 36 is made 801 in at least one tesserae shaped connecting wall 20 by using a drill, a punch, scissors, a saw, a thermal burner head, or other available perforating or cutting means commonly used in the marketplace for this function. The first falls box 6 is then secured in its final location 802 using cement, glue, earth, compacted soil, or other currently available means commonly used to secure large garden plastic items in a garden setting. A second falls box 6 is then placed adjacent to the first falls box 803 where it must be secured in its final location. In another possible disclosed method, the falls boxes 6 is secured to an adjacent falls box 6 and secured together as a group before the attached falls as a whole are placed in its final location 802 using cement, glue, earth, compacted soil, or other currently available means commonly used to secure large garden plastic items in a garden setting. A hole is then made in the tesserae shaped connecting wall 20 of the second falls using a perforating means 804 and the first guiding hole 36 as a guide. A fixation means 805 is then inserted through the first guiding hole 36 and the newly created second hole and then secured 806 using a classical securing means of fixation. Fixation means and associated securing means include a bolt and a screw or other such fixation devices commonly found in hardware stores. As illustrated in FIG. 8B, in the preferred embodiment, a bolt and a nut is used. It is also possible to remove sections 807 of the adjacent and secured walls 20 in order to increase the flow between both falls boxes. A cutting means is used to remove these sections of the tesserae shaped connecting walls 20 secured in their final location. The use of industrial silicone is contemplated in order to optimize the fixation means.

All openings made in tesserae shaped connecting walls 20 either allow flow from one falls box 6 to an adjacent falls box 6 or create a waterfall if the falls box is located next to a depression 24.

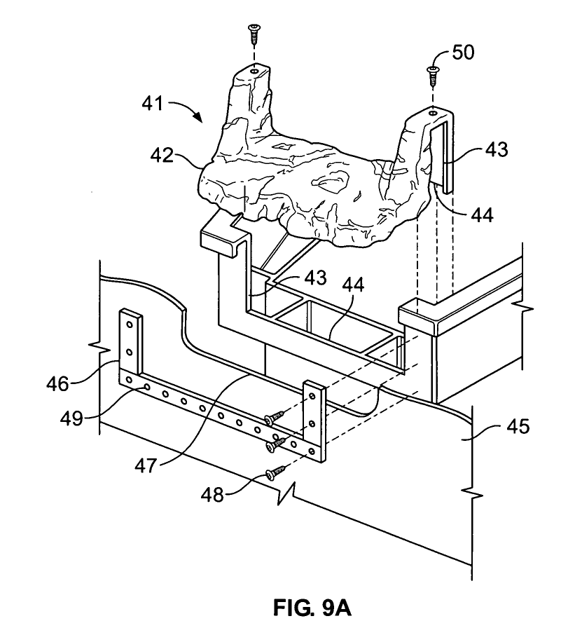

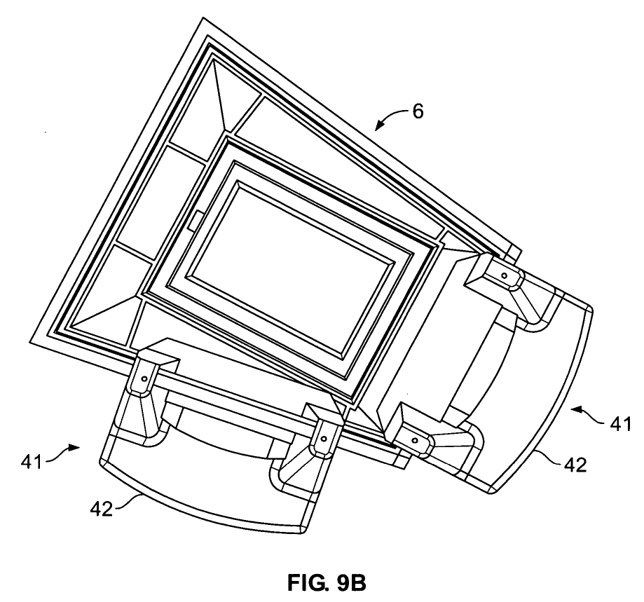

Openings can be made at any radial location around the periphery of the tesserae shaped connecting wall 20, in any quantity so as to create artificial flows or artificial waterfalls. In the preferred embodiment, up to two openings are made. In order to better guide the flow of water from the falls box 6 next to a depression 24, a spout 41 can be used. In the preferred embodiment, rocks are laid flat on the surface of the opening at the desired length and held in place using some type of industrial hardening medium. FIG. 9A illustrates a false ledge 42 that may be used in order to create a spout 41. The false ledge 42 is made of molded plastic and is installed as shown on FIG. 9A. An opening of a fixed height 43 and a fixed width 44 associated with the false ledge 42 is cut in the tesserae shaped connecting wall 20. An adjacent opening is made in the pond liner 45. A modular pond-liner attachment strip 46 is then cut into sections and placed around the liner periphery 47 adjacent to the opening in the falls box 6. In a preferred embodiment, three sections are placed around the liner periphery 47 adjacent to the opening in the falls box 6. A series of regular mechanical fixations means 48, such as plastic rivets or plastic snaps or other fixation means commonly found in hardware stores, are used to pinch the pond liner 45 to the falls box 6. In the preferred embodiment, regular holes 49 are cut in the attachment strip 46 to facilitate the use of the fixation means 48. Holes are also made around the opening in the tesserae shaped connecting wall 20. Once the pond liner 45 is secured to the falls box 6, the false ledge 42 is slid on top of the opening as shown in FIG. 9A. In the preferred embodiment, two fixation bolts 50 are used to maintain the false ledge 42 in place. A plurality of equivalent fixation means is contemplated. FIG. 9B shows a further preferred embodiment where a single falls box is equipped with two false ledges 42.

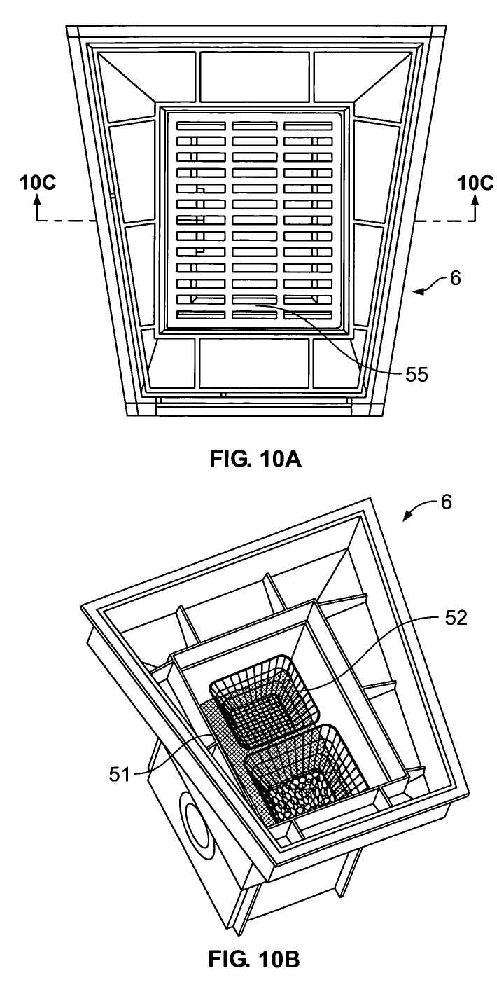

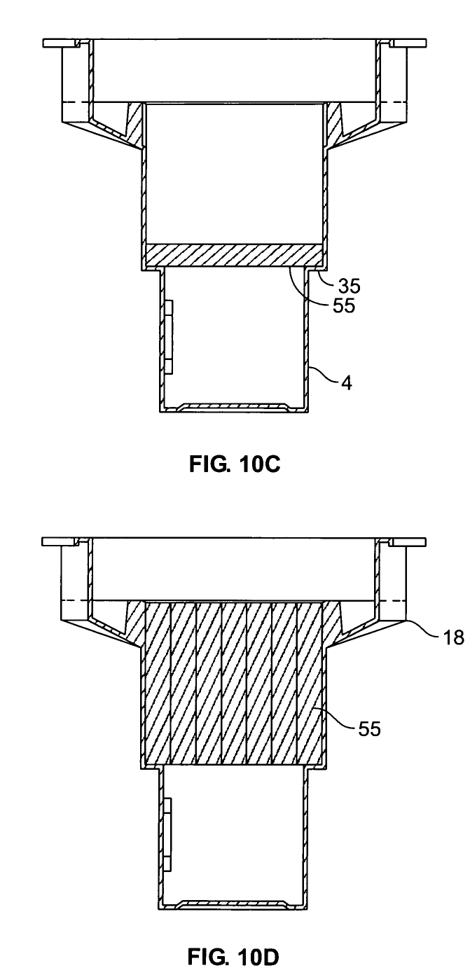

The water inlet 34 into a falls box 6 is generally located near the bottom of the falls box 6. This allows for the circulating flow of water or liquid to stabilize before reaching the surface. Depending on the need and configuration of the falls, it may be necessary to add filtration mats 51 or other filtration devices 52, such as rocks, soft materials, or semicompact plastic. FIG. 10A illustrates a falls box with a support grid 55 resting on the horizontal ledge 35. FIG. 10C is a frontal cut-off view of FIG. 10A showing where a support grid 55 rests on ledge 35 of the falls box 6. The support grid serves to hold any filling that may be needed in the falls box as shown in FIG. 10B. FIG. 10B illustrates a preferred embodiment where a composition of the filtration mats 51, rocks, and semicompact plastic is used.

The support grid 55 is made of semicompact plastic where water can circulate through the volume. FIG. 10D illustrates an embodiment where a series of support grids 55 is used in the vertical position to fill the volume where filling may be found desirable. The vertical position of the horizontal ledge 35 is designed to be at such a location to allow the top portion of the support grids 55, when positioned vertically, to arrive substantially close in altitude to the top edge of the side wall 18.

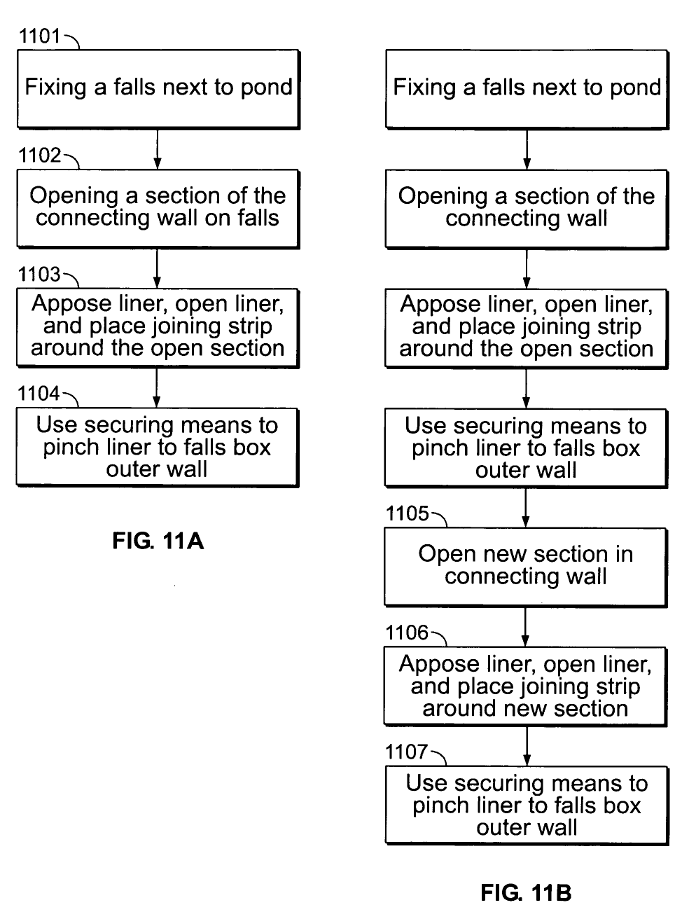

A specific method for securing a pond liner to a falls box 6 is shown in FIGS. 11A and 11B. This method allows for the fixation of the upper periphery of the pond liner around openings where waterfalls are created. First, a falls box 6 or a composite falls 29 is secured 1101 adjacent to a pond 3. An opening is made in a falls box 6 where a waterfall is desired 1102. The pond liner 45 is then apposed next to the opening 1103. A section of the pond liner 45 around the upper periphery of the pond liner is cut corresponding to the opening made in the falls box 1104. A securing means 60, such as a linear attachment strip 46, may be used to pinch the liner to the falls box 1104. The same steps are repeated (1105, 1106,1107) if a second section is opened in falls box 6.

In the preferred embodiment illustrated by FIGS. 3A to 5, the top edge of the side wall 18 has a larger periphery 63 than the periphery 62 of the side wall 16. A section reduction wall 64 is used to connect the bottom edge of the side wall 18 to the top edge 62 of the side wall 16. A thin, vertical support rib 65 is attached upwardly adjacent to the top edge of the side wall 16. Vertical support ribs 10 as illustrated in FIG. 5 may also be used to create a substantially horizontal support structure 66 as illustrated in FIG. 3A. Plants, rocks, and other decorative elements may be placed on the horizontal support structure to better camouflage the falls box 6.

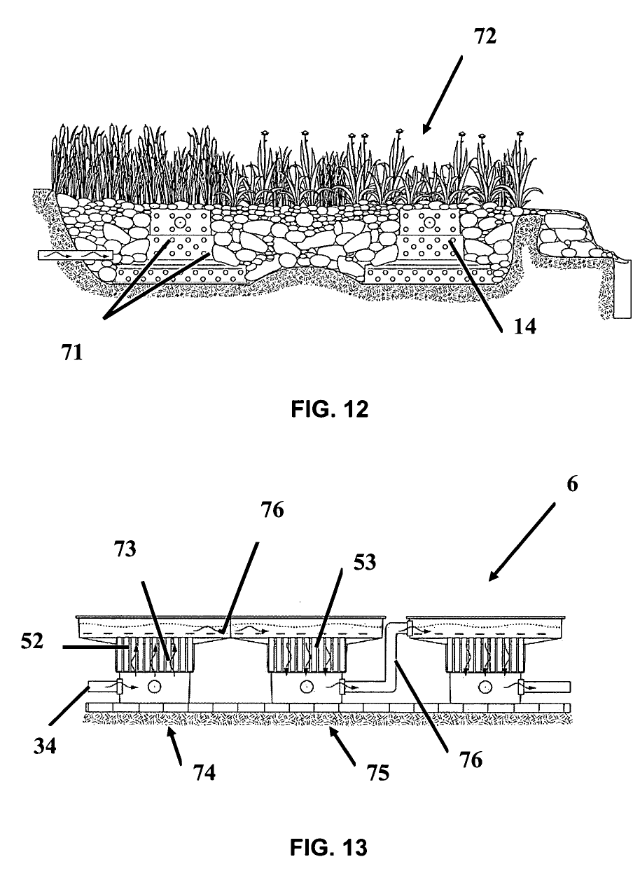

FIGS. 12 to 15B illustrate a plurality of auxiliary arrangements that may be performed using the falls box 6 in order to achieve other functions within the same technical field. FIG. 12 illustrates a situation where one or more of the container 14 of the falls box is turned upside down and covered with a plurality of flow holes 71 in a liquid saturated environment 72, such as a water and rock basin, a marsh, or other such natural or man-made liquid saturated environment. This configuration allows for liquid to flow through the liquid saturated environment 72 and form liquid volumes within the container 14. This allows for better water flow across the liquid saturated environment 72 to maintain a volume of water in case of dry situations and to optimize the biochemical formulation of the liquid saturated environment 72.

In another auxiliary arrangement, illustrated by FIG. 13, a plurality of falls boxes 6 can be arranged in a serial configuration where liquid flows from one falls box 74 to the next falls box 75 via a means of transfer 76, either an aperture, a water inlet, a tube, or other means. Liquid enters the first falls box 74 through an inlet 34 and then flows upwards 73 in the cavity of the container 14 of the first falls 74 through a first filtration system 52. Liquid is then transferred by means 76, either gravity, pressure differential, forced flow, or pumping force, to a second falls box 75. Liquid is then moved downward through a second filtration system 53, such second system being of equivalent definition as the first filtration system 52. The resulting system allows for better overall filtration and a different control of the flow. In a preferred embodiment, this configuration is used as a Koi pond filtration system.

In yet another auxiliary arrangement illustrated by FIGS. 14A to 14C, a falls box 6 is placed in a liquid saturated environment 72 and either covered or filled with elements from the liquid saturated environment 72, such as rocks, sand, or other debris. A liquid circulation means 77, such as a submersible pump, is placed on the bottom of the falls box 6 and circulates water from a lower elevation 78 to a higher elevation 79 located above the liquid saturated environment surface. Liquid then returns to the liquid saturated environment surface under the attraction of gravity, creating a water flow and some type of water feature or fountain in the process. Liquid can also be circulated to a second falls box 75 as shown in FIG. 15B. In the arrangement of FIG. 15C, the falls box 6 is either placed in a liquid-saturated environment 72 or simply buried in the ground and is filled with liquid to create a small artificial pond 82.

In yet another auxiliary arrangement illustrated by FIG. 15A, a falls box 6 is inserted right side up 81 or upside down in the liquid saturated environment 72. The volume created inside the container 14 of the falls box 6 is equipped with a circulating means 77. The circulating means circulates the water either to an elevation above the surface 79 of the liquid saturated environment or to a second falls box 75.

The foregoing is considered illustrative of the principles and method of use of the invention only. Further, since numerous modifications and changes will readily occur to those skilled in the art, it is not desired to limit the invention to the exact construction, operation, and method shown and described, and accordingly, all suitable modifications and equivalents may be resorted to, falling within the scope of the invention.

1. In a landscaping pond system, a tesserae falls box comprising:
a container containing liquid having a side wall and a bottom wall, said side wall having a bottom edge and a top edge, wherein said bottom wall attached to said bottom edge of the side wall; and
a connecting wall of tessellate shape, said connecting wall also having a bottom edge and a top edge;
wherein the bottom edge of said connecting wall attached to said top edge of the side wall.

2. The tesserae falls box of claim 1, wherein part of the outer periphery of the connecting wall is located next to landscaping features and part of the connecting wall is located next to a single or a multiplicity of depressions in order to create a single or a multiplicity of cascades.

3. The tesserae falls box of claim 1, wherein said connecting wall has at least one opening to create a preferential flow of liquid across a surface created by the top edge of the connecting wall.

4. The tesserae falls box of claim 1, wherein the falls box is tessellated to at least one related falls box of an associated tessellate shape by a connecting means, creating a composite falls with an upper periphery formed by the union of the surface of each tesserae falls box.

5. The tesserae falls box of claim 1, further comprising a liquid inlet through which liquid is added, said inlet is positioned on the container in order to create a flow of water across the volume of water resulting in a naturally occurring flow or a aesthetically pleasing manmade flow across the surface of falls box.

6. The tesserae falls box of claim 1, wherein the tessellate shape is an isosceles trapezoid.

7. The composite falls of claim 3, wherein the falls boxes are attached together in such a fashion as to create either an irregular shaped mimicking a naturally occurring stream, a body of water, or any other manmade aesthetically pleasing pattern.

8. The composite falls of claim 3, wherein part of the outer periphery of the composite falls is located next to landscaping features and part of the outer periphery is located next to a single or a multiplicity of depressions in order to create a single or a multiplicity of cascades.

9. The composite falls of claim 8, wherein at least one tesserae falls box further comprises a liquid inlet through which liquid is added, said inlet is positioned on the container in order to create a flow of water across the volume of water resulting in a naturally occurring flow or a aesthetically pleasing manmade flow across the surface of the composite falls.

10. The composite falls of claim 7, wherein the side wall of the container is of a geometry allowing vertical stacking falls boxes.

11. The composite falls of claim 7, wherein the tessellate shape of each tesserae falls box forming the composite falls is an isosceles trapezoid.

12. A method for joining at least two falls that can tessellate to form a composite falls using a fixation means, the method comprising the steps of: perforating at least one hole in a connecting wall on a first tesserae falls box by using a perforating means; securing the first tesserae falls box at a first location; positioning a second tesserae falls box adjacent to the first falls box according to a desired layout; using one hole perforated in the connecting wall of a first falls box as the guide for perforating a second hole into the connecting wall of a second falls box geometrically connecting falls; perforating the second hole in the connecting wall of the second geometrically connecting falls; inserting a fixation means through the resulting adjacent holes; and securing the fixation means using a securing means.

13. The method of claim 12, further comprising the step of: using a cutting means to open a flow section in both secured adjacent connecting wall of geometrically connecting shape.

14. The method of claim 12, wherein the fixation means is a bolt.

15. The method of claim 13, wherein the fixation means is a bolt and an industrial sealing compound.

16. The method of claim 12, wherein the first tesserae falls box secured at a first location is composed of a plurality of tesserae falls boxes joined together using regular methods;

17. In a landscaping pond system, a falls box comprising:
a container containing liquid having a bottom wall and a side wall, said side wall having a bottom edge and a top edge, said bottom wall attached to said bottom edge of the side wall, a lateral wall also having a bottom edge, and a top edge; said bottom edge of the lateral wall being attached to the top edge of the side wall;
a liquid inlet located on the side wall;
at least a depression created by placing the container above a body of water; and
wherein at least one predetermined section of the lateral wall is opened in order to create a preferential flow path for the liquid entering the containing from the liquid inlet;
wherein said flow creates a falls if the preferential flow path is located next to at least the depression;
wherein said flow creates a surface flow if the preferential flow path is located next to a second analogous falls box.

18. The falls box of claim 17, further comprising a second lateral wall opening creating a second preferential flow path for the liquid to flow from the liquid inlet outside of the falls box.

19. The falls of claim 17, wherein the height and the width of the section to be opened is determined by the equivalent height and width of a false ledge to be attached to the lateral wall of the falls in order to create a sprout.

20. The falls of claim 17, wherein the height and the width of a second section to be removed is determined by the equivalent height and width of the section of a second false ledge to be inserted over the removed second section of the lateral wall of the falls in order to create a sprout.

21. In a landscaping pond system, a falls box comprising:
a water inlet;
a support grid; and
a container having a bottom wall and a side wall, said side wall having a bottom edge, a ledge, a liquid inlet, and a top edge, said bottom wall attached to said bottom edge of the side wall, said liquid inlet located on the side wall at an altitude between the bottom edge and said ledge;
wherein the support grid is horizontally rested on the ledge when a internal volume of the container is opened;
wherein a plurality of the support grid, is vertically rested on the ledge in order to occupy the internal volume of the container;
wherein the ledge is located at such a distance under the top edge as to allow for the vertically stacked support grids to occupy substantially the internal volume of the container.

22. The falls of claim 21, wherein the internal volume of the container is filled with filtering materials when a single support grid is rested horizontally on the ledge.

23. The falls of claim 21, wherein the ledge is further located on the side wall at such a distance under the top edge as to allow for the bottom edge of a first falls box to rest on the ledge of a second falls box when a plurality of containers are stacked, in order to minimize the height of a plurality of stacked containers.

24. In a landscaping pond system, a modular pond-liner attachment system to a falls box comprising:
a container having a bottom wall and a side wall, said side wall having a bottom edge and a top edge, said bottom wall attached to said bottom edge of the side wall, a connecting wall of tessellate shape, said connecting wall also having a bottom edge and a top edge, the bottom edge of said connecting wall attached to said top edge of the side wall; wherein at least one section of the lateral wall is opened creating a depression over a body of water;
a pond liner, said pond liner having a top periphery reaching the top edge of the connecting wall of tessellate shape in which a section was cut to open a section where the lateral wall is opened in the connecting wall; and
a fixation strip with regularly spaced fixation means;
wherein said pool liner top edge is of similar geometry as the associated top edge of the connecting wall of tessellate shape;
wherein said fixation strip is cut at the length of the periphery of the opened section of the lateral wall of the container;
wherein said fixation strip is secured to the periphery of the opening section of the lateral wall of the container by the fixation means pinching the top edge of the pond liner to the periphery of the open section of the lateral wall.

25. The falls system of claim 24, further comprising: a false rock ledge attached to the top edge of the side wall covering the periphery of the opening creating a sprout.

26. The falls system of claim 24, wherein said fixation means of the fixation strip is small watertight attachment rivets.

27. A method for securing a pond lining to a falls, the method comprising the steps of: fixing a falls box next to a pond; opening a section of the connecting wall of tessellate shape next to the pond; apposing the pond liner on the connecting wall with a opened section; opening a section in the pond liner adjacent to the opening in the connecting wall of the falls box; using a fixation strip cut around the periphery of the opening in the connecting wall and the pond liner; and using a securing means to pinch the pond liner to the connecting wall.

28. The method of claim 27, further comprising the steps of: opening new sections of the connecting wall of tessellate shape next over a depression; apposing the pond liner on the connecting wall next to each such opened section; opening sections in the pond liner adjacent to the new openings; using fixations strips cut to the length of each opening around the created peripheries by the opening of the connecting wall and the pond liner; and using securing means to pinch the pond liner to the connecting wall at each periphery.

29. In a landscaping pond system, a falls box comprising:
a container containing liquid having a bottom wall and a side wall, said side wall having a bottom edge and a top edge, said bottom wall attached to said bottom edge of the side wall;
a section reduction wall, having a bottom edge and a top edge, wherein said bottom edge of the reduction wall has a shorter periphery than the periphery of the top edge of the reduction wall, said bottom edge of the section reduction wall is attached to the top edge of the side wall of the container, said section reduction wall has a thin vertical support rib attached upwardly adjacent to said bottom edge of the section reduction wall, said section reduction wall also has internal thin strengthening ribs forming a grid like support structure attached to the inside side of the section reduction wall between both edges; and
a tessellated shape connecting wall, said connecting wall also having a bottom edge and a top edge, the bottom edge of said connecting wall attached to said top edge of the section reduction wall, wherein said ridges are of limited visibility when immersed under a liquid while still offering lateral gripping surface.

30. The falls of claim 29, wherein the thin vertical support rib and the internal strengthening ribs are not higher than the top edge of the section reduction wall in order not to obstruct the flow through any opening made in the tessellated shape connecting wall.

31. The falls box of either claim 1, 17, 21, or 29, wherein a plurality of flow holes are perforated in the container, said falls box being buried upside-down or right-side-up in a liquid saturated environment.

32. The falls box of either claim 1, 17, 21, or 29, wherein a plurality of falls boxes are arranged in series, forming a global filtration system, said filtration system comprising at least a first falls box where liquid arrives via an inlet and flows upwards through a first filtration system, a means to transfer liquid from the first falls box to an adjacent falls box, and at least a downward flow through a second filtration system.

33. The falls box of either claim 1, 17, 21 or 29, wherein the container is buried in a liquid saturated environment, a liquid circulating means is located within the cavity of the container, and a liquid circulated to a higher elevation than the liquid saturated environment surface in order to create a water flow back onto the liquid saturated environment, said cavity generally being filled or covered by elements from the liquid saturated environment.

34. The falls box of claim 33, wherein said liquid being circulated is connected to the inlet of a second falls box.

35. The falls box of claim 34, wherein the falls box buried in a liquid saturated environment is upside down.

36. The falls box of either claim 1, 17, 21 or 29, wherein the container is buried in the ground or a liquid-saturated environment, a liquid circulating means is located within the cavity of the container, and a liquid is circulated to a higher elevation than the liquid-saturated environment surface in order to create a waterfall onto the liquid-saturated environment, said cavity generally being filled with water in order to create a small pond.
